(19) United States
(12) Patent Application Publication
(10) Pub. No.: US 2019/0043085 A1
(43) Pub. Date: Feb. 7, 2019

(54) SELECTING CONTENT BASED ON USER EVENTS

(71) Applicant: Facebook, Inc., Menlo Park, CA (US)

(72) Inventors: Adam Scott Berger, New York, NY (US); Nikhil Girish Nawathe, New York, NY (US); Keenan Christopher Pridmore, Chicago, IL (US)

(21) Appl. No.: 15/671,137

(22) Filed: Aug. 7, 2017

(51) Int. Cl. G06Q 30/02; G06F 17/30

(52) U.S. Cl. CPC G06Q 30/0255; H04L 67/22; G06F 17/30867

(57) ABSTRACT

An online system includes a method for identifying content to provide to a user of the online system. The online system receives a request to present content to users of the online system. The request may include a hierarchy of moments, wherein each moment of the hierarchy of moments is associated with a content creative. The online system identifies an impression opportunity to present the content to a user of the online system. The online system identifies a set of candidate moments occurring for the user from the hierarchy of moments. The online system selects a moment from the set of candidate moments based on the hierarchy of moments. The online system finally identifies the content creative associated with the identified moment, and then presents the content creative to the user.

### BACKGROUND

This disclosure generally relates to identifying content to present to users of an online system. Specifically, this disclosure relates to using a hierarchy of moments related to a content item to identify a content creative to present to a user.

In general, a content item is intended to persuade individuals that view the content item to engage in a desired behavior related to the content item. In many cases, an individual is more likely to be persuaded to engage in the desired behavior associated with the content item if the content item is relevant to the individual. For example, an individual may be more likely to engage in the desired behavior associated with the content item if the content item pertains to a moment (e.g. an event or occurrence) related to the individual. Thus a method is needed to select and serve content to individuals based on moments that are relevant to the individuals at the time the content is served.

### SUMMARY

This disclosure describes a method for identifying content to provide to a user of an online system. The online system receives, from a third party system, a request to present content from a content campaign to users of the online system. In some embodiments, the content campaign includes a hierarchy of moments, wherein each moment of the hierarchy of moments is associated with a content creative. A moment is an event that occurs at a specific point in time. For example, a moment might be the occurrence of a college graduation. As another example, a moment might be a user's post indicating a need for a new apartment. A hierarchy of moments is a ranked list of moments.

An ordering of the moments in a hierarchy of moments may be specified by the third party system or by the online system. During the content campaign, the ordering of the moments within the hierarchy may change. In some embodiments, the ordering of the moments may be suggested or automatically adjusted during the content campaign. In certain embodiments, the ordering of moments may be based in part on a learned value of each moment. The learned value of each moment may be based on an estimated probability of a user fulfilling an objective associated with a content creative that is associated with the moment. This probability may be based on data gathered by tracking the actions of users that have previously been presented with the content creative. In further embodiments, the ordering of moments may be based in part on trending topics. Trending topics may be current events tending in the news, or current events known based on a date. In certain embodiments, the lowest ranked moment in the hierarchy may be designated as an “other” moment that is a default moment selected for users for whom no other moments in the hierarchy of moments are applicable.

In certain embodiments, the content campaign initiated by the third party system may also include a bid amount used to bid on an impression opportunity for a user. In further embodiments the content campaign may include general targeting criteria that specify one or more characteristics of users eligible to be presented with the content. Furthermore, each moment of the hierarchy of moments may be associated with moment targeting criteria that specify one or more characteristics of users eligible to be associated with the moment, and thus eligible to receive the associated content creative.

Following receipt of the content request from the third party system, the online system identifies an impression opportunity to present the content associated with the content campaign to a user of the online system. In some embodiments, general targeting criteria that specify one or more characteristics of users eligible to be presented with the content are used to identify the impression opportunity.

Next the online system identifies a set of candidate moments occurring for the user. In some embodiments, the moments in the set of candidate moments are selected from the hierarchy of moments included in the content request by the third party system. The moments may be identified for a user based on user fulfillment of moment targeting criteria associated with each moment. In some embodiments, if the user does not fulfill targeting criteria for any moments from the hierarchy of moments, the online system may select the “other” moment for the user as a default.

The online system then selects a moment for the user from the set of candidate moments. In some embodiments, this selection is based on the hierarchy of moments. Specifically, in some embodiments, the moment selected for the user is the highest ranked moment for the user.

The time at which a moment is selected for a user may differ in various embodiments. In some embodiments, a moment is pre-selected for the user for a given campaign before the opportunity to present the user with the content occurs. In such embodiments, to pre-select a moment for the user from the hierarchy of moments, the online system identifies the highest ranked moment of the hierarchy of moments that has been performed by the user at the given time, and then stores an association between the user's profile and the identified moment. When an opportunity to present content to the user is identified, the online system queries the user's profile to identify the moment that has been pre-selected for the user.

In alternative embodiments, a moment is not pre-selected for the user. Rather, a moment that is selected for a user is identified only after the opportunity to present the user with a content creative is identified. In this embodiment, after the opportunity to present the user with a content creative has been identified, the online system identifies the highest ranked moment of the hierarchy of moments that has been performed by the user.

Next, the online system identifies the content creative that is associated with the moment selected for the user. Finally, the online system presents the identified content creative to the user. By presenting content that is most relevant to a user at a given time, the probability that the user will engage in a desired behavior associated with the content is increased.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for selecting a content creative to present to a user, in accordance with an embodiment.

FIG. 4A illustrates a content campaign, in accordance with one embodiment.

FIG. 4B illustrates a diagram depicting user fulfillment of moment targeting criteria associated with the moments of FIG. 4A, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

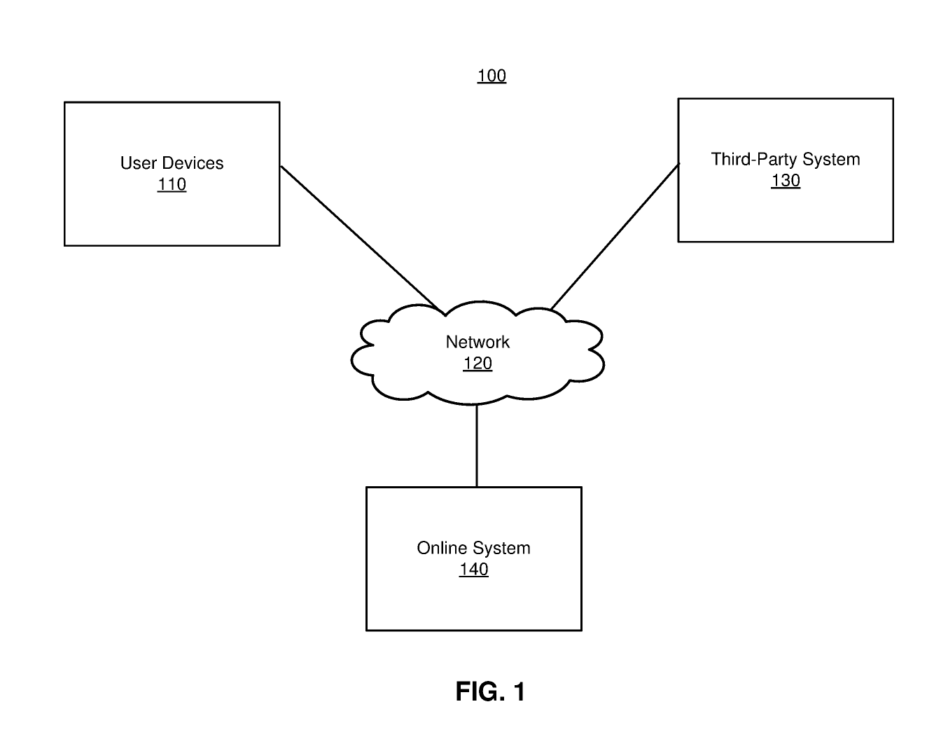

FIG. 1 is a block diagram of a system environment 100 for an online system 140 that serves content to users of the online system 140 via a network 120. In some embodiments, the content served by the online system 140 may be received by the online system 140 from one or more third party systems 130.

The system environment 100 shown by FIG. 1 comprises one or more client devices 110, the network 120, one or more of the third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

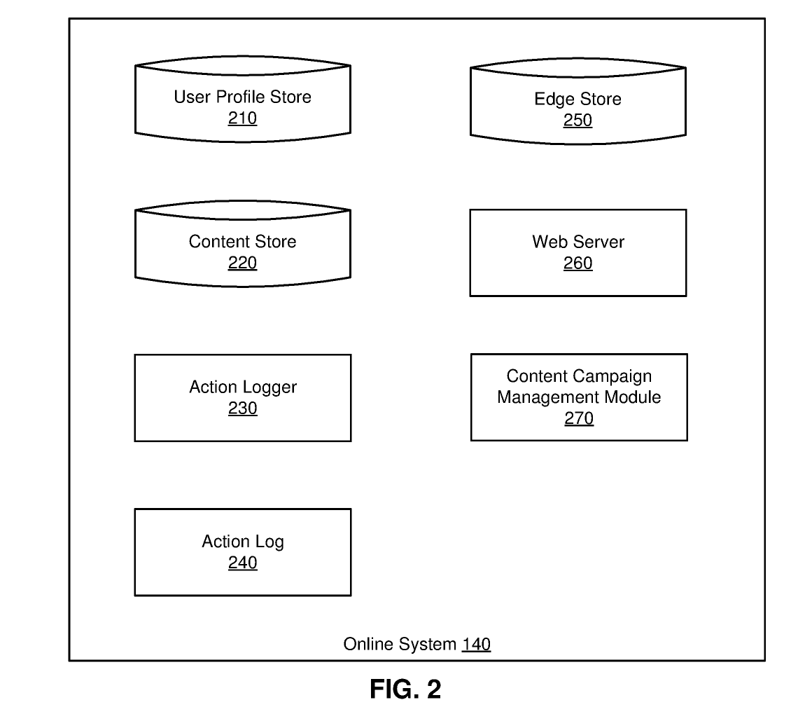

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. In the embodiment provided herein, the online system 140 includes components that enable the online system 140 to provide content to users of the online system 140 based on the identity and experiences of the users. Specifically, the online system 140 shown in FIG. 2 includes a user profile store 210, a content store 220, an action logger 230, an action log 240, an edge store 250, a web server 260, and a content campaign management module 270. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 210. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 210 may also maintain references to actions by the corresponding user performed on content items in the content store 220 and stored in the action log 240.

In some embodiments, a user profile in the user profile store 210 may maintain references to one or more “moments” that have been selected for the user. A moment is an event that occurs at a specific point in time, such as a birthday, purchase of a new car, or upcoming sporting event. Moments may be defined by the online system 140 or by a third party system 130. Selection of moments for users is described in greater detail below with regard to the content campaign management module 270.

While user profiles in the user profile store 210 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 220 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 220, such as status updates, photos tagged by users to be associated with other objects in the online system 140, events, groups or applications. In some embodiments, objects are received from third-party applications or third-party applications separate from the online system 140. In one embodiment, objects in the content store 220 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 220 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a third party system 130 that provides the content item and is used to determine an expected value, such as monetary compensation, provided by the third party system 130 to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from the third party system 130 who provided the content item to the online system 140 if content in the content item is displayed. In some embodiments, the expected value to the online system 140 of presenting the content from the content item may be determined by multiplying the bid amount by a probability of the content of the content item being accessed by a user.

In various embodiments, a content item includes various components that can be identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety. As another example, the online system 140 may select a specific version of a content item, known as a “content creative,” to present to a user based on information associated with that user. For instance, in one embodiment, a content creative may be selected for presentation to a user based on moments selected for the user and stored in the user's profile 210. Such embodiments are discussed in greater detail with regard to the content campaign management module 270.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

In embodiments in which content creatives are presented to users, tracking user fulfillment of objectives associated with the content creatives enables the online system 140 to determine the efficacy of given content creatives. This data can be used by the online system 140 to determine which content creatives to present to which users in future iterations of the content campaign. This embodiment is discussed in greater detail with regard to the content campaign management module 270.

A content item may include one or more general targeting criteria specified by the third party system 130 that provided the content item to the online system 140. General targeting criteria included in a content item request specify one or more characteristics of users eligible to be presented with the content item. For example, general targeting criteria are used to identify users having user profile information or actions satisfying at least one of the general targeting criteria. Hence, general targeting criteria allow the online system 140 to identify users having specific characteristics, simplifying subsequent distribution of content to different users.

In one embodiment, general targeting criteria may specify actions or types of connections between a user and another user or object of the online system 140. General targeting criteria may also specify interactions between a user and objects performed external to the online system 140, such as on a third party system 130. For example, general targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other action. Including actions in general targeting criteria allows users to further refine users eligible to be presented with content items.

In embodiments in which various content creatives are presented to users, moment targeting criteria may be used in addition to or instead of general targeting criteria to determine which specific content creative to present to which user. For example, fulfillment of a specified moment as defined by moment targeting criteria may determine whether a user is eligible to receive a content creative associated with the specified moment. This embodiment is discussed in greater detail with regard to the content campaign management module 270.

The action logger 230 receives communications about user actions internal to and/or external to the online system 140, populating the action log 240 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 240.

The action log 240 may be used by the online system 140 to track user actions on the online system 140, as well as actions on third party systems 130 that communicate information to the online system 140. Users may interact with various objects on the online system 140, and information describing these interactions is stored in the action log 240. Examples of interactions with objects include: commenting on posts, sharing links, checking-in to physical locations via a client device 110, accessing content items, and any other suitable interactions. Additional examples of interactions with objects on the online system 140 that are included in the action log 240 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 240 may record a user's interactions with advertisements on the online system 140 as well as with other applications operating on the online system 140. In some embodiments, data from the action log 240 is used to infer interests or preferences of a user, augmenting the interests included in the user's user profile and allowing a more complete understanding of user preferences.

The action log 240 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 240 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 230 by the application for recordation and association with the user in the action log 240.

In one embodiment, the third party system 130 uses a tracking pixel or piece of HTML code placed by the third party system 130 on third-party websites to monitor users visiting the websites that have not opted out of tracking. A tracking pixel might be included on various pages, including on a product page describing a product, on a shopping cart page that the user visits upon putting something into a shopping cart, on a checkout page that the user visits to checkout and purchase a product, etc. For example, a tracking pixel results in a transparent 1×1 image, an iframe, or other suitable object being created for third party pages. When a user's browser loads a page having the tracking pixel, the tracking pixel results in the user's browser attempting to retrieve the content for that pixel, and the browser contacts the online system 140 to retrieve the content. The request sent to the online system 140 may include various data about the user's actions taken on the third party website. The third party website can control what data is sent to the online system 140. For example, the third party system 130 may include information about the page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party's user identifier (UID) for the user, contact information for the user, etc.), and other data. In some embodiments, a cookie set by the online system 140 can also be retrieved by the online system 140, which can include various data about the user, such as the online system 140s′ identifier for the user, information about the client device and the browser, such as the Internet Protocol (IP) address of the client device, among other data. Tracking can also be performed on mobile applications of content providers by using a software development kit (SDK) of the online system 140 or via an application programming interface (API) of the online system 140 to track events that occur by users on the content provider's app that are reported to the online system 140.

In one embodiment, the edge store 250 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 250 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 250, in one embodiment. Alternatively, each interaction between a user and a specific object is stored as a separate edge. In some embodiments, connections between users may be stored in the user profile store 210, or the user profile store 210 may access the edge store 250 to determine connections between users.

The web server 260 links the online system 140 via the network 120 to the one or more client devices 110, as well as to the one or more third party systems 130. The web server 260 serves web pages, as well as other content, such as JAVA®, FLASH®, XML and so forth. The web server 260 may receive and route messages between the online system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 220. Additionally, the web server 260 may provide application programming interface (API) functionality to send data directly to native client device operating systems, such as IOS®, ANDROID™, or BlackberryOS.

The content campaign management module 270 manages the presentation of content associated with content campaigns to users. Specifically, the content campaign management module 270 receives requests from third party systems 130 to present content to users of the online system 140, and uses a hierarchy of moments to determine which content creatives to present to which users.

In embodiments provided herein, a content campaign executed by the content campaign management module 270 may include a hierarchy of moments. As described above, a moment is an event that occurs at a specific point in time. In one embodiment, a moment may be related to a group of people. For example, a moment might be a news event such as the election of a national leader. This moment may pertain to different subsets of the world population based on information stored about those subsets in the user profile store 210, the content store 220, the action log 240, or the edge store 250. Such moment targeting criteria is discussed in greater detail below. In another embodiment, a moment may occur in association with a single user. For example, a moment might be the occurrence of a birthday. As another example, a moment might be a recent post to the online system 140 that indicates a user's interest in the Golden State Warriors basketball team. Moments that occur in relation to a user may be stored in the user's profile within the user profile store, the content store 220, the action log 240, or the edge store 250. A hierarchy of moments is an ordered list of moments. In other words, a hierarchy of moments is a set of moments in which each moment in the set is associated with a particular ranking.

Moments within a hierarchy of moments that is associated with a content campaign may be specified by a third party system 130 associated with the campaign, or by the online system 140. Furthermore, the ordering of the moments within the hierarchy may be specified by the third party system 130, or by the online system 140. During the progression of the content campaign, moments may be added or removed from the hierarchy. Additionally, the ordering of moments within the hierarchy may also change. In certain embodiments, the lowest ranked moment in the hierarchy of moments may be designated as an “other” moment that is a default moment selected for users for whom no other moments in the hierarchy of moments are applicable. Ordering of moments within a hierarchy of moments is discussed in further detail below.

In some embodiments, each moment of a hierarchy of moments is associated with a unique content creative. A content creative is a content item that is related to content of a content campaign associated with the hierarchy. In other words, content creatives are different versions or iterations of content associated with the content campaign. Content creatives for each moment can be specified by the third party system 130 or the online system 140. In one embodiment, each content creative may be formatted differently. In another embodiment, each content creative may include slightly different content. In a further embodiment, each content creative may include content related to the specific moment with which the content creative is associated.

As an example, a content campaign may request distribution of content promoting a venue for hosting a party. Thus the content creatives associated with each moment of the hierarchy of moments associated with the content campaign may all be related to promotion of the party venue. Furthermore, the content creative for each moment may also be related to the specific moment itself. For instance, a content creative for the party venue campaign that is associated with the moment of the election of a national leader might include text reading “Celebrate the start of a new era at an elegant venue.” As another example, a content creative for the party venue campaign that is associated with the birthday moment might include an image of a person blowing out candles on a cake with a large group of people surrounding them. Finally, a content creative for the party venue campaign that is associated with the moment of a recent post expressing interest in the Golden State Warriors might include text reading “Celebrate this year's championship team at a venue large enough for 100 die-hard fans.” In embodiments in which the hierarchy of moments includes an “other” moment, a generic content creative for the content campaign may be used. For example, a content creative for the party venue campaign that is associated with the “other” moment might include text reading “Host your dream party today!”

By determining which moments apply to a user, the content campaign management module 270 may present the user with a content creative that is most relevant to the user within a unified campaign. Specifically, the user may be presented with a content creative that is associated with a moment that is related to the user. For a moment to be selected for a user, the user must fulfill certain moment targeting criteria associated with the moment. In some embodiments, moment targeting criteria for each moment is specified by the third party system 130 or the online system 140. The online system 140 determines whether a user fulfills moment targeting criteria for a given moment by analyzing information about the user stored in one or more of the user profile store 210, the content store 220, the action log 240, and the edge store 250. By presenting the user with a relevant content creative, the content campaign management module 270 effectively increases the likelihood that the user will interact with the content creative, and perform the objective associated with the content campaign.

Continuing with the above example, one moment associated with the content campaign promoting the party venue might be the election of a national leader. As discussed above, this moment may pertain to different subsets of the world population based on information stored about those subsets in the user profile store 210, the content store 220, the action log 240, or the edge store 250. Specifically, if the moment is the election of a United States president, moment targeting criteria for this moment may specify that the moment pertains to all users of the online system 140 that are determined to be United States citizens based on information stored by the online system 140.

As another example, another moment associated with the content campaign promoting the party venue might be a recent post to the online system 140 that indicates a user's interest in the Golden State Warriors. Moment targeting criteria used to determine whether this moment pertains to a given user might be that the user shared a link to content on the Golden State Warriors' official page within the last 2 months. Based on fulfillment of moment targeting criteria for the Golden State Warriors post moment, the user may be presented with the party venue content creative for the moment that reads “Celebrate this year's championship team at a venue large enough for 100 die-hard fans.”

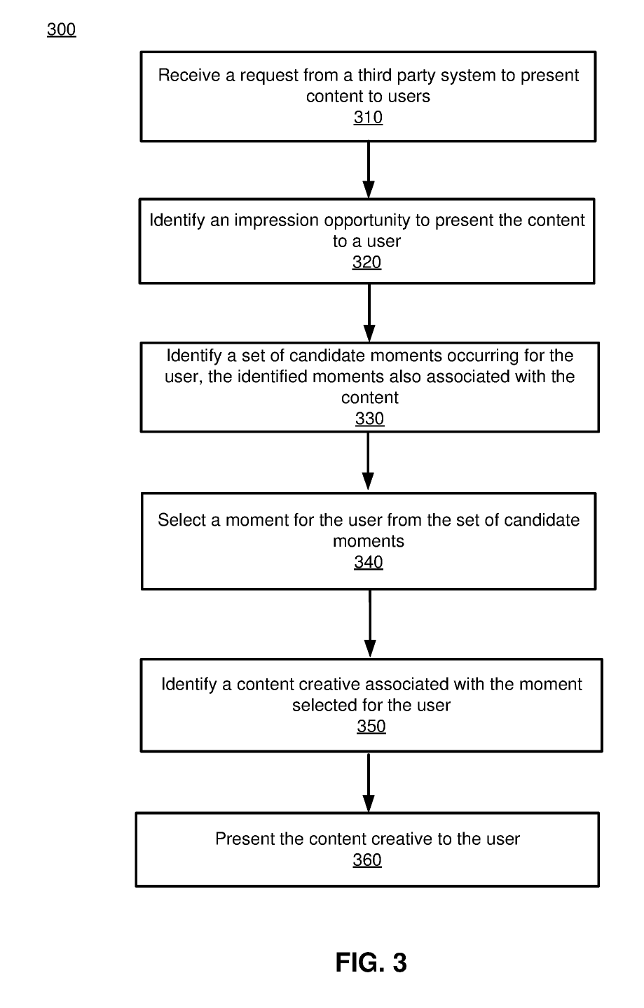

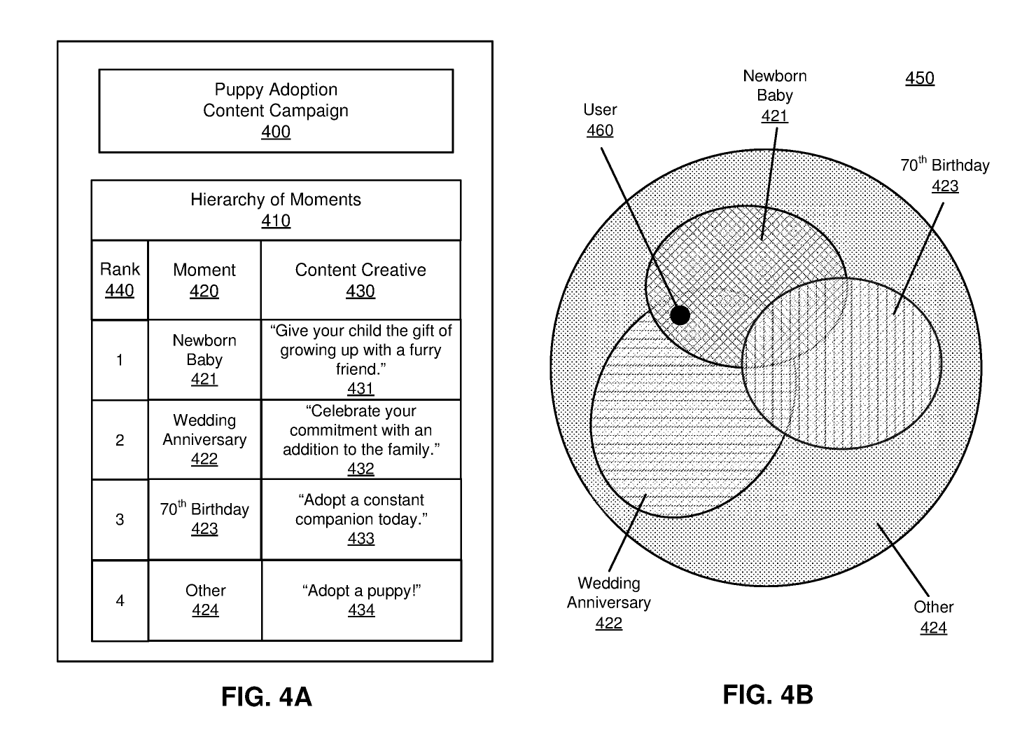

In some embodiments, a moment is selected for a user that is targeted by a content campaign before the user has been chosen to be presented with content from the campaign. In alternative embodiments, a moment is selected for a user after the user has been chosen to be presented with content from the content campaign. The timing at which a moment is selected for a user is discussed in greater detail below with regard to FIGS. 3-4B.

In some cases, a plurality of moments specified by a content campaign may be selected for a user. For instance, referring back to the example above in which a content campaign promotes a party venue, the online system 140 may determine that a user's birthday is approaching, and that the user is a fan of the Golden State Warriors. In such cases in which a user fulfills targeting criteria for a plurality of moments, the content campaign management module 270 determines which content creative to present to the user—the content creative associated with the occurrence of a birthday, or the content creative associated with the Golden State Warriors post. The hierarchy of moments for the content campaign is used to determine which content creative to present to the user. Specifically, the hierarchy of moments is used to identify the highest ranked moment of the hierarchy of moments that has been identified for the user. When the birthday moment is ranked higher in the hierarchy of moments than the Golden State Warriors post moment, the moment of the approaching birthday would be determined as the highest ranked moment for the user. Based on this identification of the birthday moment as the highest ranked moment for the user, the content campaign management module 270 presents the content creative associated with the birthday moment to the user.

In alternative cases, zero moments specified by the content campaign may be selected for a user. In such cases, the default “other” moment that is described above may be selected for the user, and the content campaign management module 270 presents the generic content creative associated with the “other” moment to the user.

The ordering of moments within a hierarchy of moments may be based on a variety of factors. As noted above, in some embodiments, the third party system 130 and/or the online system 140 may specify the order of the moments. In further embodiments, the ordering of the moments may be suggested or automatically adjusted by the content campaign management module 270 during the campaign. For example, in certain embodiments, the ordering of moments may be based in part on a learned value of the individual moments as the content campaign proceeds. Specifically, the moments within the hierarchy of moments may be ordered such that a content creative with the greatest probability of objective fulfillment when presented to a user is ranked first within the hierarchy of moments, and a content creative with the lowest probability of objective fulfillment when presented to a user is ranked last within the hierarchy of moments. A probability of objective fulfillment for a content creative may be estimated using data gathered by tracking the actions of users that have previously been presented with the content creative. As noted above, in some embodiments the default “other” moment may be ranked lowest within the hierarchy of moments.

In some embodiments, moments may be related to trending topics and the ordering of moments may be based in part on trending topics. Trending topics may be current events tending in the news, or current events known based on a date. As one example, assume the Anaheim Angels baseball team recently won the World Series, and this event is trending in the news. In response to such a trend, a content campaign promoting a sports apparel store might re-order moments of the hierarchy to place a moment of a recent purchase of Anaheim Angels tickets as number one within a hierarchy of moments associated with the campaign. As another example, assume the date is Aug. 30, 2017. It is well known that around this date, children return to school. Based on this known date and the associated event of returning to school, a content campaign promoting office supplies might up-rank a moment that indicates that a user's child is returning to school within a hierarchy of moments associated with the campaign.

FIG. 3 is a flow chart of a method 300 for selecting a content creative to present to a user of the online system 140, in accordance with an embodiment. In other embodiments, the method may include different and/or additional steps than those shown in FIG. 3. Additionally, steps of the method may be performed in different orders than the order described in conjunction with FIG. 3 in various embodiments.

The online system 140 receives 310 a request from a third party system 130 to present content to users. As described above, a content request from a third party system 130 may include a bid amount and a hierarchy of moments, where each moment of the hierarchy is associated with a unique content creative. In some embodiments, the content request may include general targeting criteria that specify one or more characteristics of users eligible to be presented with the content. Furthermore, each moment of the hierarchy of moments may be associated with moment targeting criteria that specify one or more characteristics of users eligible to be associated with the moment, and thus eligible to receive the associated content creative.

The online system 140 identifies 320 an impression opportunity to present the content to a user. In embodiments in which general targeting criteria that specify characteristics of users eligible to be presented with the content of the content request are provided in step 310, these general targeting criteria are used to identify users eligible to receive the content.

The online system 140 identifies 330 a set of candidate moments occurring for the user, the identified moments also associated with the content. As described above, in some embodiments, the content request of step 310 includes a hierarchy of moments related to the content of the content request. The set of candidate moments are identified from the moments included in this hierarchy of moments. As described above, candidate moments may be identified for a user based on user fulfillment of moment targeting criteria.

The online system 140 selects 340 a moment for the user from the set of candidate moments. In some embodiments, this selection is based on the hierarchy of moments. Specifically, in some embodiments, the moment selected for the user is the highest ranked moment for the user.

The time at which a moment is selected for the user may differ in various embodiments. In some embodiments, a moment is pre-selected for the user after the impression opportunity has been identified, but before the user has been chosen to receive content from the third party system 130. To pre-select a moment for the user, the online system 140 selects the highest ranked moment of the hierarchy of moments that has been identified for the user at the given time. Then the online system 140 stores an association between the user's profile and the selected moment. Finally, when the user has been chosen to receive content from the third party system 130, the online system 140 queries the user's profile to identify the moment that has been pre-selected for the user. In some embodiments, pre-selection of moments for users eligible for content presentation may occur automatically and periodically. For example, example, pre-selection of a moment for a user may be performed bi-weekly. Thus the same moment is not always stored in association with a user. The moment selected for a user may change based on an altered ordering of the moments in a hierarchy of moments, or based on the occurrence of moments over time.

In alternative embodiments, a moment is not pre-selected for the user. Rather, a moment is selected for the user only after the user is chosen to be presented with content from the third party system 130. In this embodiment, after the user is chosen to be presented with content from the third party system 130, the online system 140 identifies a set of candidate moments for the user in step 330, and then selects the highest ranked moment from the set of candidate moments in step 340. This selected moment may or may not be stored in association with the user's profile.

The online system 140 identifies 350 a content creative associated with the moment selected for the user in step 340. As described above, each moment of the hierarchy of moments is associated with a unique content creative. The content creative that is associated with the moment selected for the user in step 340 is identified.

The online system 140 presents 360 the content creative to the user. The online system 140 then monitors the actions of the user to determine whether presentation with the content creative encourages the user to perform an objective associated with the content request. The ranking of the moments within the hierarchy of moments can be altered based on this data as described above.

FIGS. 4A and 4B illustrate an example of selecting a content creative to present to a user, in accordance with an embodiment.

FIG. 4A illustrates a content campaign, in accordance with one embodiment. Specifically, FIG. 4A depicts a puppy adoption content campaign 400. The puppy adoption content campaign 400 includes a hierarchy of moments 410. The hierarchy of moments 410 includes four distinct moments 420, each associated with a content creative 430 and a rank 440. A first moment that is associated with rank of ‘1’ within the hierarchy of moments 410 is a newborn baby 421. The content creative 431 that is associated with the newborn baby 421 reads: “Give your child the gift of growing up with a furry friend.” A second moment that is associated with rank of ‘2’ within the hierarchy of moments 410 is a wedding anniversary 422. The content creative 432 that is associated with the wedding anniversary 422 reads: “Celebrate your commitment with an addition to the family.” A third moment that is associated with rank of ‘3’ within the hierarchy of moments 410 is a 70^{th} birthday 423. The content creative 433 that is associated with the 70^{th} birthday 423 reads: “Adopt a constant companion today.” Finally, a fourth moment that is associated with rank of ‘4’ within the hierarchy of moments 410 is an “other” moment 424. The “other” moment is a default moment that is selected for users for whom no other moments in the hierarchy of moments are applicable. The content creative 434 that is associated with the “other” moment 424 reads: “Adopt a puppy!”

FIG. 4B illustrates a diagram 450 that depicts user fulfillment of moment targeting criteria associated with the moments 420 of FIG. 4A. All users depicted in FIG. 4B have been determined to fulfill general targeting criteria that specify characteristics of users eligible to be presented with at least the content creative 434 associated with the “other” moment 424. Users that fall only within the “other” category 424 are by default presented with the “other” content creative 434. But because the “other” category 424 has the lowest rank 440, users that fall within additional categories aside from the “other” category 424 are eligible to be presented with an alternative content creative 430 that is associated with a moment 420 with a higher rank 440.

The diagram 450 can be used to determine which content creative 430 to present to a given user categorized within the diagram 450. As one example, a user 460 is provided in FIG. 4B. The user 460 is located within the diagram 450 such that the user 460 fulfills moment targeting criteria associated with the following moments: the newborn baby 421, the wedding anniversary 422, and the “other” moment 424. Thus the diagram 450 indicates that the user 460 is eligible to receive the content creative 431, 432, and 434. A few distinct embodiments of selection of a content creative for the user 460 are described below.

First, assume that a moment has not been pre-selected for the user 460. Thus, the content creative 430 that is associated with the highest-ranked moment 420 related to the user 460 is selected for presentation to the user 460 after the user 460 has been chosen to receive content. As the user 460 fulfills the moment targeting criteria for the top-ranked newborn baby moment 421, in this embodiment, the user 460 would be presented with the content creative 431.

As a distinct, alternative example, assume that a moment has been pre-selected for the user 460. For example, assume that at the time that a moment 420 was pre-selected for the user 460, the user 460 had fulfilled moment targeting criteria for the wedding anniversary moment 422 and the “other” moment 424. Because the highest-ranked moment associated with the user 460 at the time of pre-selection was the wedding anniversary moment 422, a profile of the user 460 was pre-associated with the wedding anniversary moment 422. However, further assume that after the wedding anniversary moment 422 was pre-selected for the user 460, the user 460 experienced the arrival of the user's newborn baby. If the user 460 is chosen for presentation with a content creative before the user's pre-selection is updated, the user 460 will be presented with the content creative 432 for the wedding anniversary moment 422, even though the user 460 now fulfills moment targeting criteria for the higher-ranked moment of the newborn baby 421.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for identifying content to provide to a user, the method comprising:
receiving, from a third party system, a request to present content associated with a content campaign to users of an online system, the content campaign including a hierarchy of moments, wherein a moment is an event that occurs at a specific point in time, and wherein each moment of the hierarchy of moments is associated with a content creative;
identifying an impression opportunity to present the content associated with the content campaign to a user of the online system;
identifying, from the hierarchy of moments of the content campaign, a set of candidate moments occurring for the user;
selecting, from the set of candidate moments, based on the hierarchy of moments, a moment for the user;
identifying, the content creative associated with the moment selected for the user; and
presenting the content creative to the user.

2. The method of claim 1, wherein selecting a moment for the user further comprises:
prior to identifying the impression opportunity:
selecting, from the set of candidate moments occurring for the user, based on the hierarchy of moments, a highest ranked moment for the user; and
associating a profile of the user with the moment.

3. The method of claim 1, wherein selecting a moment for the user further comprises:
after identifying the impression opportunity:
selecting, from the set of candidate moments occurring for the user, based on the hierarchy of moments, a highest ranked moment for the user.

4. The method of claim 2, wherein the steps of selecting a highest ranked moment for the user and associating a profile of the user with the moment recur periodically over time.

5. The method of claim 1, wherein identifying an impression opportunity to present the content associated with the content campaign to a user of the online system further comprises:
receiving general targeting criteria from the third party system, the general targeting criteria specifying characteristics of users eligible to receive the content associated with the content campaign; and
identifying an impression opportunity to present the content associated with the content campaign to a user of the online system, the user fulfilling the general targeting criteria received from the third party system.

6. The method of claim 1, wherein identifying a set of candidate moments occurring for the user further comprises:
receiving moment targeting criteria for each moment of the hierarchy of moments from the third party system, the moment targeting criteria for each moment specifying characteristics of users eligible to be associated with the moment; and
for each moment of the hierarchy of moments, determining whether the user fulfills the moment targeting criteria for the moment.

7. The method of claim 1, wherein an ordering of the moments within the hierarchy of moments is based at least in part on an estimated value of each of the moments.

8. The method of claim 7, wherein the estimated value of a moment is based on a probability that a user will fulfill an objective associated with the moment when the user is presented with a content creative associated with the moment.

9. The method of claim 8, wherein the probability that a user will fulfill an objective associated with the moment when the user is presented with a content creative associated with the moment is based on data obtained by tracking actions of users of the online system that have previously been presented with the creative content.

10. The method of claim 1, wherein an ordering of the moments within the hierarchy of moments is based at least in part on trending topics, wherein trending topics include one or more of current events trending in the news or current events known based on a date in time.

11. The method of claim 1, wherein an ordering of the moments within the hierarchy of moments can be altered during the content campaign.

12. The method of claim 1, wherein a content creative associated with a moment includes content related to the moment.

13. A computer program product for identifying content to provide to a user, the computer program product comprising a computer-readable storage medium containing computer program code for:
receiving, from a third party system, a request to present content associated with a content campaign to users of an online system, the content campaign including a hierarchy of moments, wherein a moment is an event that occurs at a specific point in time, and wherein each moment of the hierarchy of moments is associated with a content creative;
identifying an impression opportunity to present the content associated with the content campaign to a user of the online system;
identifying, from the hierarchy of moments of the content campaign, a set of candidate moments occurring for the user;
selecting, from the set of candidate moments, based on the hierarchy of moments, a moment for the user;
identifying, the content creative associated with the moment selected for the user; and
presenting the content creative to the user.

14. The computer program product of claim 13, wherein identifying a moment that is associated with the user further comprises:
prior to identifying the impression opportunity:
selecting, from the set of candidate moments occurring for the user, based on the hierarchy of moments, a highest ranked moment for the user; and
associating a profile of the user with the moment;

15. The computer program product of claim 13, wherein identifying a moment that is associated with the user further comprises:
after identifying the impression opportunity:
selecting, from the set of candidate moments occurring for the user, based on the hierarchy of moments, a highest ranked moment for the user.

16. The computer program product of claim 14, wherein the steps of selecting a highest ranked moment for the user and associating a profile of the user with the moment recur periodically over time.

17. The computer program product of claim 13, wherein identifying an impression opportunity to present the content associated with the content campaign to a user of the online system further comprises:
receiving general targeting criteria from the third party system, the general targeting criteria specifying characteristics of users eligible to receive the content associated with the content campaign; and
identifying an impression opportunity to present the content associated with the content campaign to a user of the online system, the user fulfilling the general targeting criteria received from the third party system.

18. The computer program product of claim 13, wherein identifying a set of candidate moments occurring for the user further comprises:
receiving moment targeting criteria for each moment of the hierarchy of moments from the third party system, the moment targeting criteria for each moment specifying characteristics of users eligible to be associated with the moment; and
for each moment of the hierarchy of moments, determining whether the user fulfills the moment targeting criteria for the moment.

19. The computer program product of claim 13, wherein an ordering of the moments within the hierarchy of moments is based at least in part on an estimated value of each of the moments.

20. The computer program product of claim 19, wherein the estimated value of a moment is based on a probability that a user will fulfill an objective associated with the moment when the user is presented with a content creative associated with the moment.

21. The computer program product of claim 20, wherein the probability that a user will fulfill an objective associated with the moment when the user is presented with a content creative associated with the moment is based on data obtained by tracking actions of users of the online system that have previously been presented with the creative content.

22. The computer program product of claim 13, wherein an ordering of the moments within the hierarchy of moments is based at least in part on trending topics, wherein trending topics include one or more of current events trending in the news or current events known based on a date in time.

23. The computer program product of claim 13, wherein an ordering of the moments within the hierarchy of moments can be altered during the content campaign.

24. The computer program product of claim 13, wherein a content creative associated with a moment includes content related to the moment.
